(19) United States
(12) Patent Application Publication
(10) Pub. No.: US 2007/0021894 A1
(43) Pub. Date: Jan. 25, 2007

(54) Method for initiating start-up of an electrical system

(75) Inventors: Wayne David Brandt, Morton, IL (US); Vernon Richard Smith, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/185,704

(22) Filed: Jul. 21, 2005

(51) Int. Cl. G06F 7/70

(52) U.S. Cl. 701/50

(57) ABSTRACT

A method for starting a work machine includes receiving information corresponding to a current configuration of at least one component of the work machine. The method also includes comparing the received information to information corresponding to a previous configuration of the at least one component. The method further includes providing a data request signal if the received information corresponding to the current configuration of the at least one component is not substantially similar to the information corresponding to the previous configuration of the at least one component. The method also includes providing a start-up signal if the received information is substantially similar to the information corresponding to the previous configuration of the at least one component.

### TECHNICAL FIELD

This application relates generally to a work machine and, more particularly to a system and method for initiating start-up of a work machine.

### BACKGROUND

Work machines such as, for example, track-type tractors, on-highway vehicles, off-highway vehicles, wheel loaders, excavators, skid steer loaders, or generator sets may employ a start-up sequence wherein an equipment system, upon realizing a initial start-up request, queries the electrical and/or mechanical systems of the work machine for status and configuration settings. Upon receipt of the query, each system logs onto the network by identifying itself, signaling where the component is in the system, and updating the system of the function and status of the component, one component at a time until all components are identified. The network evaluates the system configuration data and determines if the system is in a condition to allow proper start-up operation of the system. Because work machines include large numbers of components and subsystems, each transmitting a substantial amount of data, the status monitoring and configuration analysis of the system on start-up may take a substantial amount of time. This delay could lead to personnel and equipment unproductiveness. Furthermore, such a delay in system start-up could cause the operator to prematurely reattempt to start the system, which could lead to damage of the components and/or the system.

Some attempts have been made to develop a method for more efficiently evaluating configuration data of electronic systems prior to starting a vehicle. For example, U.S. Patent Application Publication No. 2005/0004726 (the '726 publication), to Paquet published on Jan. 6, 2005, describes a method that updates a configuration file for an electronic module upon vehicle start-up. The '726 publication describes a vehicle control system that determines a correct value of a configuration parameter of an electronic module and stores the correct value with the electronic module prior to starting the system. In particular, the system of the '726 publication collects values of parameters stored in a plurality of electronic modules of the vehicle, decides which of the collected values should be maintained as the correct value based on a majority voting method, and sends and/or stores the correct value of the parameter to electronic modules that did not provide the correct value. The system releases the network for start-up once the appropriate values have been assigned to the electronic modules.

Although the system of the '726 publication may provide a method for determining values of configuration parameters during start-up of a vehicle, the system may be problematic. For example, the system and method described in the '726 publication may have limited configuration control capabilities. The system described in the '726 publication may be limited in determining whether or not a module is transmitting a correct configuration parameter to methods that are based upon values received from other modules on the network. For example, the system described in the '726 publication determines and assigns “correct” configuration parameters based upon the parameters of a majority of electronic modules on the network. Should one or more of the electronic modules be substantially different from a majority of the other modules, it may erroneously be assigned a configuration parameter for an incompatible module. Since the system of the '726 publication does not verify the correctness of configuration parameters based upon each particular module, a module that may not submit a particular configuration value may be determined by the other modules on the network to be incorrect, and may erroneously be assigned incompatible configuration parameters. This could result in improper functioning of one or more of the modules and could potentially damage the modules and/or the system itself.

The presently disclosed system and method are directed to overcoming one or more of the problems set forth above.

### SUMMARY OF THE INVENTION

In accordance with one aspect, the present disclosure is directed to a start-up system of a work machine. The system may include a plurality of work machine components. The system may also include a plurality of data collection nodes, each data collection node configured to provide information corresponding to a current configuration of a respective work machine component. The system may further include a status collection node in communication with the plurality of data collection nodes, the status collection node configured to receive information corresponding to the current configuration of each of the plurality of work machine components, compare the received information to information corresponding to a previous configuration of each of the plurality of work machine components, provide a data request signal if the received information is not substantially similar to the previous configuration of at least one of the plurality of work machine components, and provide a start-up signal if the received information is substantially similar to the previous configuration of each of the plurality of work machine components.

According to another aspect, the present disclosure is directed to a method for starting a work machine. The method may include receiving information corresponding to a current configuration of at least one component of the work machine. The method may also include comparing the received information to information corresponding to a previous configuration of the at least one component. The method may further include providing a data request signal if the received information corresponding to the current configuration of the at least one component is not substantially similar to the information corresponding to the previous configuration of the at least one component. The method may also include providing a start-up signal if the received information is substantially similar to the information corresponding to the previous configuration of the at least one component.

In accordance with yet another aspect, the present disclosure is directed to a method for collecting configuration information of at least one component of a work machine. The method may include collecting the information corresponding to the current configuration of the at least one component at a status collection node. The method may also include storing the collected information for use in a start-up system of the work machine. The method may further include determining a start-up condition of the at least one component based on the collected information.

### BRIEF DESCRIPTION OF THE DRAWINGS

FIG. 1 provides a diagrammatic illustration of an exemplary disclosed work machine;

FIG. 2 provides a schematic illustration of an exemplary disclosed start-up system for the work machine in FIG. 1; and

FIG. 3 illustrates a flowchart depicting an exemplary disclosed method for operating the start-up system of FIG. 2.

### DETAILED DESCRIPTION

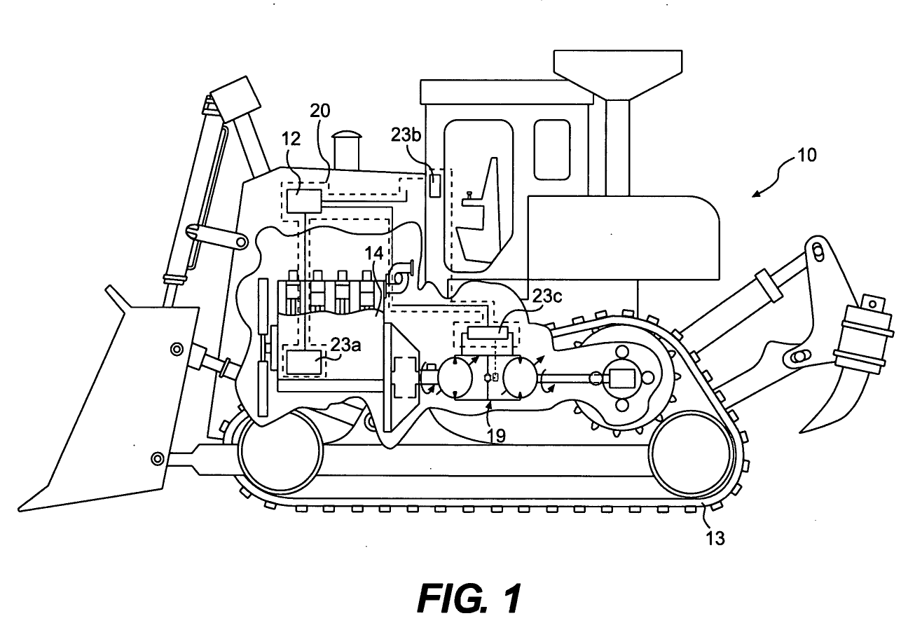

FIG. 1 provides a diagrammatic view of work machine 10 according to an exemplary disclosed embodiment. Work machine 10 may be a stationary or mobile machine that performs some type of operation associated with an industry such as mining, construction, farming, transportation, or any other industry know in the art. Work machine 10 may include, among other things, a power source 14, a transmission 19, and a start-up system 20. While work machine 10 is illustrated as a track-type tractor, work machine 10 may embody any type of work machine that includes one or more systems operable to perform a particular function. For example, work machine 10 may embody an on-highway vehicle, an off-highway vehicle, a wheel loader, an excavator, a skid steer loader, a generator set, or any other type of machinery known in the art.

Power source 14 may be a device operable to provide a power output for various systems and components of work machine 10. Power source 14 may be coupled to one or more components of work machine 10 such as, for example, a generator for converting a portion of the power output to electric energy, a torque converter for translating power from power source 14, a cooling system for cooling various components of power source 14, a lubrication circuit for monitoring and controlling the flow rate and viscosity of power source lubricant, a fuel system for monitoring and controlling the flow rate of fuel supplied to power source 14, or any other electrical or mechanical system operable to perform a function of work machine 10. Power source 14 may include a battery, a fuel cell, or an internal combustion engine that operates using diesel fuel, gasoline, a gaseous fuel such as natural gas, or any other types of fuel.

Transmission 19 may be a device operable to transmit mechanical power from power source 14 to one or more traction devices 13. Transmission 19 may be a hydrostatic transmission, an electric transmission, a mechanical transmission, a hydro-mechanical transmission, or any other means for transmitting power from power source 14. Transmission 19 may be coupled to one or more components of work machine 10 such as, for example, a torque converter for adjusting output torque from power source 14, a motor coupled to traction device 13 for propelling and maneuvering work machine 10, a lubrication circuit for monitoring and controlling the flow rate and viscosity of hydraulic fluid within transmission 19, or any other electrical or mechanical system operable to perform a function of work machine 10.

Start-up system 20 may be operable to receive, analyze, and provide data information, as well as provide signals and commands to initiate operation of work machine 10. For example, start-up system 20 may be operable to receive information from a plurality of systems and/or subsystems, analyze the received information, provide information corresponding to the start-up configuration of power source 14, transmission 19, and/or subsystems of work machine 10, provide a start-up signal based upon the analysis of the received data information, and initiate operation of work machine 10. Start-up system 20 may include a plurality of data collection nodes 23a-c, a status collection node 12, and a start-up manager 15.

Each of data collection nodes 23a-c may include various components for running software applications. For example, each of data collection nodes 23a-c may include a central processing unit (CPU), a computer-readable memory, a random access memory (RAM), input/output (I/O) elements, etc. Each of data collection nodes 23a-c may constitute a unit dedicated to the start-up system 20. Alternatively, each of data collection nodes 23a-c may include a control unit of work machine 10.

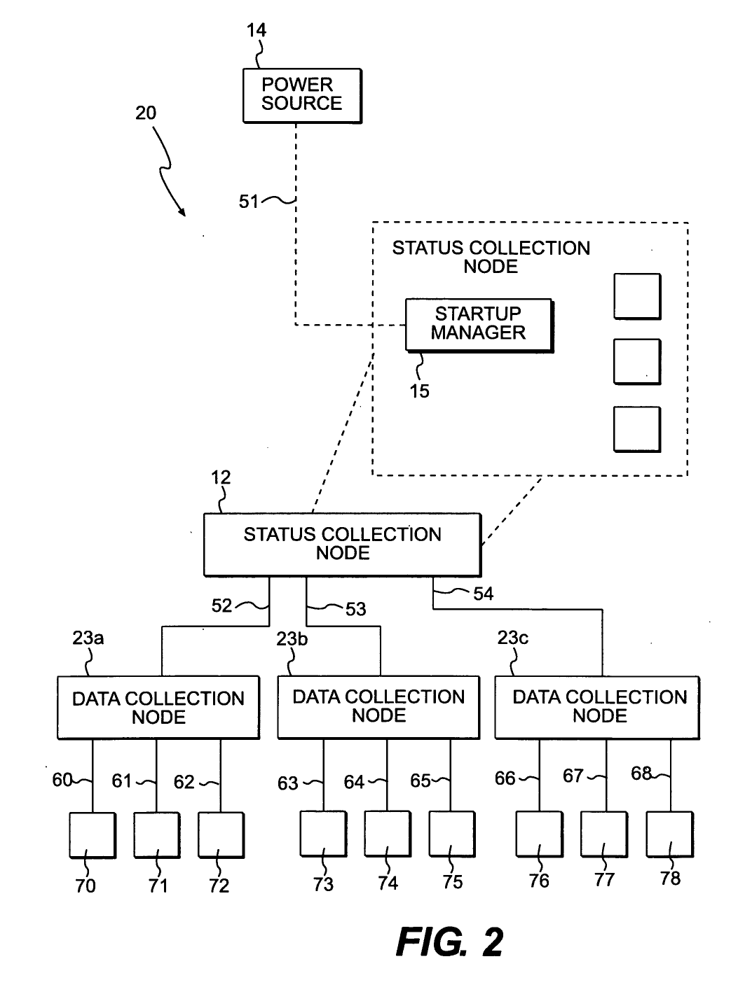

As illustrated in FIG. 2, data collection nodes 23a-c may be in communication with subsystems of work machine 10 and may be operable to monitor and control one or more of the subsystems. For example, data collection node 23a may be associated with power source 14 and operable to automatically monitor the configuration information of one or more of the electrical or mechanical systems 70-72 associated with power source 14, once a start-up sequence has been initiated. A start-up sequence, for the purposes of this disclosure, includes any event that indicates that operation of work machine 10 is imminent. This may include, for example, when a user of work machine 10 inserts a key into the ignition system, when the systems of work machine 10 are provided a power signal, when a network is brought online, or any such indication, which triggers an operation of work machine 10. Configuration information, for the purposes of this disclosure, may include a signal corresponding to the current physical address and digital signature of a particular electrical and mechanical system of work machine 10. The digital signature may include information corresponding to a particular status of the system, such that a change in the digital signature corresponds to a change in system status. For example, configuration information may include an analog signal, a digital signal, coded indicia, an encrypted data signal, or any other signal known in the art for providing data information over a variety of media.

Similarly, data collection node 23b may be associated with transmission 19 and operable to automatically monitor the configuration information of one or more of the electrical or mechanical systems 73-75 associated with transmission 19, once a start-up sequence is realized. For example, data collection node 23b may receive configuration data from a torque converter 73 for adjusting output torque from power source 14, a motor 74 coupled to traction device 13 for propelling and maneuvering work machine 10, a lubrication circuit 75 for monitoring and controlling the flow rate and viscosity of hydraulic fluid within transmission 19, or any other electrical or mechanical system operable to perform a function of transmission 19.

Likewise, data collection node 23c may be associated with a steering system (not shown in detail) and operable to automatically monitor the configuration information of one or more of the electrical or mechanical systems 76-78 associated with the steering system, once a start-up sequence is realized. For example, data collection node 23c may receive configuration data from a pressure sensor 76 for monitoring the pressure of the power steering fluid within the steering system, a velocity sensor 77 for monitoring the speed at which the power steering pump rotates, a valve actuator 78 for controlling the position of a valve to control pressure of the power steering system, or any other electrical or mechanical system operable to perform a function of the steering system.

Data collection nodes 23a-c may be operable to automatically provide configuration information of power source 14, transmission 19, and/or other subsystems of work machine 10 to start-up system 20, once a start-up sequence is realized. For example, once power is supplied to the systems of work machine 10, data collection node 23a-c may be configured to automatically transmit the configuration information of power source 14, transmission 19, steering system, and any other systems or subsystems of work machine 10.

Data collection nodes 23a-c may be operable to provide information corresponding to a complete description of their associated subsystems upon receipt of a data request signal from start-up system 20. For example, data collection node 23a associated with power source 14 may receive a data request signal from start-up system 20. Upon receipt of the data request signal, data collection node 23a may provide information corresponding to a complete description of power source 14 or one or more of the electrical or mechanical systems 70-72 associated with power source 14. For the purposes of this disclosure, information corresponding to a complete description may include a signal corresponding to, among other things, a physical address, digital signature, part number, model number, software version, component function, component specifications, and/or one or more operational aspects of the component.

Similarly, data collection node 23b associated with transmission 19 may receive a data request signal from start-up system 20. Upon receipt of the data request signal, data collection node 23b may provide information corresponding to a complete description of transmission 19 or one or more of the electrical or mechanical systems 73-75 associated with transmission 19.

Likewise, data collection 23c associated with the steering system of work machine 10 may receive a data request signal from start-up system 20. Upon receipt of the data request signal, data collection node 23c may provide information corresponding to a complete description of the steering system or one or more of the electrical or mechanical systems 76-78 associated with the steering system.

Data collection nodes 23a-c may be communicatively coupled to power source 14, transmission 19, and/or other subsystems of work machine 10 via electrical wires, wireless channels, fiber optic cables, or any other such analog or digital communication medium known in the art. In particular, data collection nodes 23a-c may be communicatively coupled to electrical and mechanical systems (70-78) via communications lines 60-68, respectively. Communication lines 60-68 may include electrical wires, wireless channels, fiber optic cables, or any other such analog or digital communication medium known in the art.

Status collection node 12 may include start-up manager 15 and various components for running software applications. For example, status collection node 12 may include a central processing unit (CPU), a computer-readable memory, a random access memory (RAM), input/output (I/O) elements, etc. Status collection node 12 may constitute a unit dedicated to start-up system 20 or, alternatively, may include an electronic control unit of work machine 10.

Status collection node 12 may be in communication with data collection nodes 23a-c and may be operable to receive configuration information and information corresponding to a complete description from data collection nodes 23a-c. For example, once a start-up sequence is realized, status collection node may automatically receive configuration information from data collection node 23a corresponding to power source 14, data collection node 23b corresponding to transmission 19, and data collection node 23c corresponding to the steering system.

Status collection node 12 may determine whether the received configuration information corresponds to a previous configuration stored in memory and operate differently according to the determination. In particular, status collection node 12 may provide a data request signal if the information corresponding to the current configuration is not substantially similar to the information corresponding to the previous configuration and provide a start-up signal if the information corresponding to the current configuration is substantially similar to the information corresponding to the previous configuration. For example, upon receipt of the configuration information from data collection nodes 23a-c, status collection node 12 may determine whether the received configuration information and previous configuration information (i.e. configuration information stored in memory from a previously successful start-up) are substantially similar. If it is determined that the received configuration information for data collection nodes 23a-c is substantially similar to previous configuration information for data collection nodes 23a-c respectively, then status collection node 12 may provide a start-up signal, indicating that the current configurations of data collection nodes 23a-c have not changed since a previous operation of work machine 10, and are in a condition to allow operation of work machine 10. Alternatively, if it is determined that the received configuration information for any one of data collection nodes 23a-c is not substantially similar to previous configuration information of data collection nodes 23a-c, then status collection node 12 may provide a data request signal, indicating that the current configurations of one or more data collection nodes 23a-c have changed since a previous operation of work machine 10, and are not in condition to allow operation of work machine 10.

For the purposes of this disclosure, it is contemplated that substantially similar may include a condition wherein, during a comparison of two signals, the difference between the signals does not exceed a predetermined acceptable error range either in absolute terms or a percentage variation. In one example, a predetermined acceptable error range may be defined by the amount that two signals may differ without indicating a problem with the safety, performance, and/or operation of the component. It is further contemplated that this predetermined acceptable error range may be specific for a respective component. For example, a predetermined acceptable error range for a first component may differ from a predetermined acceptable error range for a second component.

Status collection node 12 may be operable to store configuration information of each of the electrical and mechanical systems of work machine 10 upon transmission of a start-up signal for later access by status collection node 12. For example, status collection node 12 may transmit a start-up signal based upon a determination that the configuration of each of the systems associated with data collection nodes 23a-c has not changed since a previous operation of work machine 10. Subsequently, status collection node 12 may store the configuration information corresponding to each of the systems associated with data collection nodes 23a-c in a configuration file associated with a successful operation of work machine 10. The status collection node may access the stored information in subsequent start-up iterations.

Status collection node 12 may be operable to query one or more data collection nodes 23a-c for information corresponding to a complete description of power source 14, transmission 19, and/or other subsystems of work machine 10 or electrical or mechanical systems 70-78 and store the information corresponding to a complete description in memory for future access by start-up system 20. For example, upon starting work machine 10 for the first time, it may be necessary query each of data collection nodes 23a-c in order to establish initial complete description data for one or more electrical or mechanical systems 70-78, since no previous description data is stored in memory. For any subsequent operation of work machine 10, query of data collection nodes 23a-c may only be necessary if current configuration data of one or more electrical or mechanical systems 70-78 associated with power source 14, transmission 19, and/or subsystems of work machine 10 is determined to be substantially dissimilar from a previous configuration data stored from a previous operation of work machine 10.

Status collection node 12 may be communicatively coupled to data collection nodes 23a-c via communication lines 52-54, respectively. Communication lines 52-54 may include electrical wires, wireless channels, fiber optic cables, or any other such analog or digital communication medium known in the art.

Start-up manager 15 may be in communication with status collection node 12 and may be operable to receive a start-up signal from status collection node 12 and initiate operation of work machine 10. For example, upon receipt of a start-up signal, start-up manager 15 may provide a network clearance signal indicating that the electrical and mechanical components of work machine 10 have been identified and initiate operation of work machine 10. Alternatively, upon receipt of a start-up signal, start-up manager 15 may provide power source 10 with authorization to initiate operation of the work machine.

Start-up manager 15 may be communicatively coupled to status collection node 12 via electrical wires, wireless channels, fiber optic cables, or any other such analog or digital communication medium known in the art or may be integrated within status collection node 12. Start-up manager may be communicatively coupled to power source 14 via a communication line 51. Communication lines 51 may include one or more electrical wires, wireless channels, fiber optic cables, or any other such analog or digital communication medium known in the art.

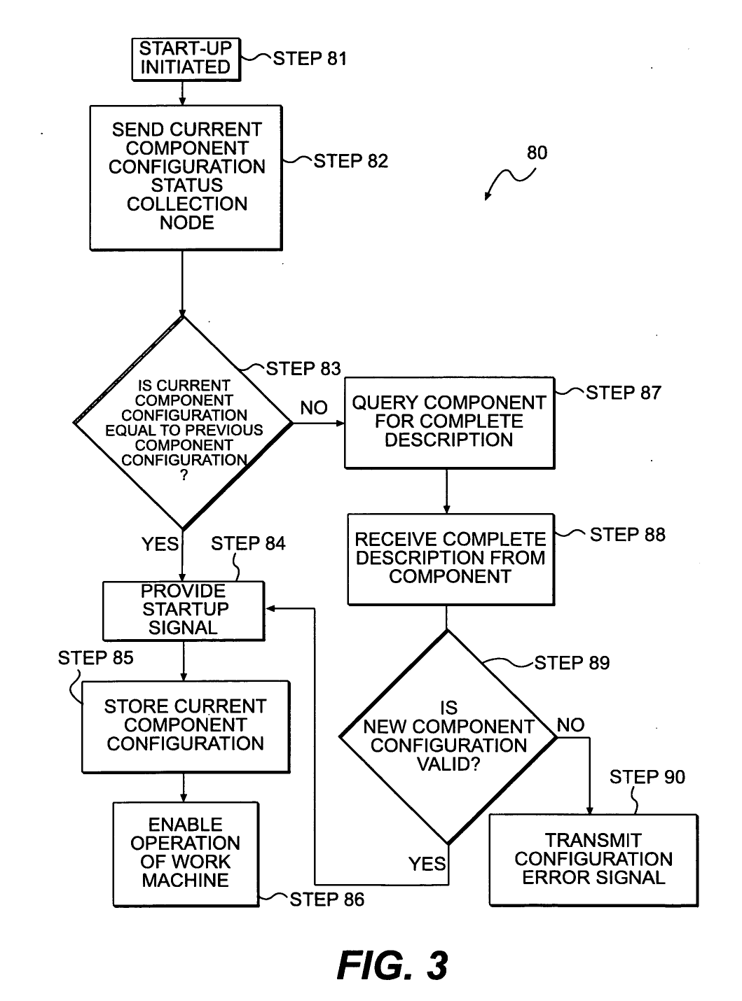

FIG. 3 illustrates a flow chart 80 depicting an exemplary method of operating start-up system 20. FIG. 3 will be described in detail below.

### INDUSTRIAL APPLICABILITY

The disclosed start-up system may be applicable to any system where it may be advantageous to verify a configuration of one or more subsystems prior to starting a system. In one exemplary disclosed embodiment the start-up system verifies, in a fast, accurate, and efficient manner, that the configuration of one or more electrical or mechanical systems has not changed from a previously successful operation of the work machine. The method of operation of start-up system 20 will now be described in detail.

As illustrated in flow chart 80 of FIG. 3, a start-up sequence of work machine 10 is initiated (Step 81) by an operator. As noted above, a start-up sequence may include any event that indicates operation of work machine 10 is imminent, for example, when an operator of work machine 10 inserts a key into the ignition system. Once initiation of start-up sequence of work machine 10 is realized, one or more of data collection nodes 23a-c may automatically provide configuration information of each component associated with the particular node to status collection node 12 (Step 82). For example, data collection node 23a may be associated with power source 14 and operable to automatically provide the configuration information of generator 70 associated with power source 14, upon realization of a start-up sequence of work machine 10.

Upon receipt of the current configuration information of each of the electrical or mechanical systems 70-78 associated with power source 14, transmission 19, and/or other subsystems of work machine 10, a determination may be made as to whether the current configuration of each component is substantially similar to a previous configuration (Step 83). For example, status collection node 12 may receive configuration information from data collection node 23a, for example, associated with generator 70 of power source 14. Status collection node 12 may determine whether the received configuration information and previous configuration information (i.e. configuration information stored in memory from a previously successful start-up) are substantially similar, thereby indicating that the current configuration has not changed from a previously successful operation of work machine 10.

If the received component configuration is substantially similar to a previous component configuration, a start-up signal may be provided indicating that the components are in a configuration suitable for starting (Step 84). The current component information may then be stored in memory as previous component information (Step 85) corresponding to the start-up signal. Upon receipt of a start-up signal, operation of work machine 10 may be enabled (Step 86). For example, status collection node 12 may determine that the received configuration information and previous configuration information of generator 70 associated with power source 14 are substantially similar. Status collection node 12 may provide a start-up signal indicating that the current configuration of the generator 70 has not changed since a previous operation of work machine 10, and is, therefore, in a condition to allow operation of work machine 10. Status collection node 12 may store the received component configuration information in memory associated with the particular start-up operation of work machine 10, and subsequently enable operation of work machine 10.

Alternatively, if the received component configuration is not substantially similar to a previous component configuration, a data request signal may be provided indicating that the one or more component are not in a configuration to enable proper operation of work machine 10. The one or more components may then be queried for a complete configuration description (Step 84). For example, status collection node 12 may determine that the received configuration information and previous configuration information of generator 70 associated with power source 14 are not substantially similar. In response to the determination, status collection node 12 may provide a data request signal, indicating that the current configuration of generator 70 associated with power source 14 has changed since a previous operation of work machine 10, and is not yet in condition to allow operation of work machine 10. Status collection node may then query data collection node 23a associated with generator 70 of power source 14 for a complete configuration description of the generator (Step 87).

Status collection node 12 receives the complete description from the one or more electrical or mechanical systems 70-78 that were determined to have realized a change in configuration (Step 88), and stores the complete configuration information in memory. For example, data collection node 23a associated with generator 70 associated with power source 14 may transmit information corresponding to a complete description of generator 70 to status collection node 12. If the new component configuration description is not valid (Step 89), then a configuration error may be communicated to the status collection node (90). If complete description information is not provided or is determined to be erroneous, an error signal may be generated and start-up sequence may be terminated, and start-up of work machine 10 may be disabled until the fault or error is corrected. Status collection node may store the description information in memory and provide a start-up signal in order to initiate operation of work machine 10. The method proceeds to Step 85 and 86 once all current configurations have been determined by status collection node 12.

It is contemplated in this disclosure that the method for starting a work machine may be repeatable for each start-up of work machine 10. Furthermore, Steps 81-88 may be performed in a different order while still achieving substantially the same operation as start-up system 20.

Start-up system 20 may increase personnel and equipment productivity. Because data collection nodes 23a-c may be configured to automatically transmit configuration information upon initiation of operation of work machine 10 to the status collection node, start-up delay may be significantly reduced in comparison with systems that query each node individually on start up.

Start-up system 20 may reduce maintenance and operational costs of work machine 10, since potential problems associated with system configuration changes may be resolved prior to the operation of work machine 10. This could significantly reduce the amount of damage caused by malfunctioning or improperly configured equipment, thereby minimizing repair costs and equipment downtime.

Furthermore, start-up system 20 may reduce the erroneous assignment of configuration values, which may result from arbitrary or general module configuration assignment methods of other systems. Since start-up system 20 may receive configuration information from one or more components or query one or more components for complete configuration descriptions, erroneous assignment of a configuration parameter is reduced.

In addition, start-up system 20 may provide significant time savings during system start-up. Since start-up of work machine 10 may based upon changes in system configuration from previous start-up sequences, which may be automatically supplied to a single status collection node 12, the need to individually query each component may be eliminated. This may substantially reduce the amount of time required to start work machine 10, which may result in significant time savings and increased production of work machine 12.

It will be apparent to those skilled in the art that various modifications and variations can be made to the disclosed start-up system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A start-up system of a work machine, comprising:
a plurality of work machine components;
a plurality of data collection nodes, each data collection node configured to provide information corresponding to a current configuration of a respective work machine component; and
a status collection node in communication with the plurality of data collection nodes, the status collection node configured to:
receive information corresponding to the current configuration of each of the plurality of work machine components,
compare the received information to information corresponding to a previous configuration of each of the plurality of work machine components,
provide a data request signal if the received information is not substantially similar to the previous configuration of at least one of the plurality of work machine components, and
provide a start-up signal if the received information is substantially similar to the previous configuration of each of the plurality of work machine components.

2. The start-up system of claim 1, wherein the plurality of data collection nodes are configured to automatically provide the information corresponding to the current configuration of the plurality of work machine components.

3. The start-up system of claim 2, wherein the plurality of data collection nodes are configured to provide information corresponding to a plurality of operational aspects of the plurality of work machine components in response to the data request signal.

4. The start-up system of claim 1, wherein the status collection node further includes a start-up manager, wherein the start-up manager is configured to initiate operation of the work machine in response to the start-up signal.

5. The start-up system of claim 4, wherein the status collection node is further configured to store the information corresponding to the current configuration of at least one of the plurality of work machine components as the information corresponding to the previous configuration of at least one of the plurality of work machine components.

6. The start-up system of claim 1, wherein the status collection node is further configured to query at least one of the plurality of data collection nodes for information corresponding to a plurality of operational aspects of at least one of the plurality of work machine components.

7. A method for starting a work machine, comprising:
receiving information corresponding to a current configuration of at least one component of the work machine;
comparing the received information to information corresponding to a previous configuration of the at least one component;
providing a data request signal if the received information corresponding to the current configuration of the at least one component is not substantially similar to the information corresponding to the previous configuration of the at least one component; and
providing a start-up signal if the received information is substantially similar to the information corresponding to the previous configuration of the at least one component.

8. The method of claim 7, further including automatically providing the information corresponding to the current configuration of the at least one component to a status collection node.

9. The method of claim 7, further including providing information corresponding to a plurality of operational aspects of the at least one component in response to the data request signal.

10. The method of claim 7, further including storing the information corresponding to the current configuration of the at least one component as the information corresponding to the previous configuration of the at least one component.

11. The method of claim 7, further including initiating operation of the work machine in response to the start-up signal.

12. A software program adapted for employing the method of claim 7.

13. A method for collecting configuration information of at least one component of a work machine, comprising:
collecting the information corresponding to the current configuration of the at least one component at a status collection node;
storing the collected information for use in a start-up system of the work machine;
determining a start-up condition of the at least one component based on the collected information.

14. The method of claim 13, wherein the information corresponding to the current configuration of the at least one component includes information corresponding to a plurality of operational aspects of the at least one component.

15. The method of claim 13, wherein the determination is further based on a comparison between the collected information and a previous configuration of the at least one component.

16. The method of claim 13, wherein collected information is automatically provided by at least one data collection node in response to a start-up sequence.

17. The method of claim 13, wherein collected information is automatically provided by at least one data collection node in response to a data request signal.

18. A work machine, comprising:
a power source; and
a start-up system of a work machine operatively coupled to the power source, the start-up system comprising:
a plurality of work machine components;
a plurality of data collection nodes, each data collection node configured to provide information corresponding to a current configuration of a respective work machine component; and
a status collection node in communication with the plurality of data collection nodes, the status collection node configured to:
receive information corresponding to the current configuration of each of the plurality of work machine components,
compare the received information to information corresponding to a previous configuration of each of the plurality of work machine components,
provide a data request signal if the received information is not substantially similar to the previous configuration of at least one of the plurality of work machine components, and
provide a start-up signal if the received information is substantially similar to the previous configuration of each of the plurality of work machine components.

19. The start-up system of claim 18, wherein the plurality of data collection nodes are configured to automatically provide the information corresponding to the current configuration of the plurality of work machine components.

20. The start-up system of claim 19, wherein the plurality of data collection nodes are configured to provide information corresponding to a plurality of operational aspects of the plurality of work machine components in response to the data request signal.

21. The start-up system of claim 18, wherein the status collection node further includes a start-up manager, wherein the start-up manager is configured to initiate operation of the work machine in response to the start-up signal.

22. The start-up system of claim 21, wherein the status collection node is further configured to store the information corresponding to the current configuration of at least one of the plurality of work machine components as the information corresponding to the previous configuration of at least one of the plurality of work machine components.

23. The start-up system of claim 18, wherein the status collection node is further configured to query at least one of the plurality of data collection nodes for information corresponding to a plurality of operational aspects of at least one of the plurality of work machine components.
